(19) United States
(12) Patent Application Publication
(10) Pub. No.: US 2009/0220151 A1
(43) Pub. Date: Sep. 3, 2009

(54) Device for adjusting image color difference value and adjusting method thereof

(75) Inventor: Hung-Shih Lin, Tainan County (TW)

Correspondence Address: RABIN & Berdo, PC, 1101 14TH STREET, NW, SUITE 500, WASHINGTON, DC, 20005, US

(73) Assignee: HIMAX TECHNOLOGIES LIMITED, Tainan County (TW)

(21) Appl. No.: 12/073,149

(22) Filed: Feb. 29, 2008

(51) Int. Cl. G06K 9/00

(52) U.S. Cl. 382/167

(57) ABSTRACT

A three-dimensional color difference value adjusting method for adjusting a selected region of an image is provided. The method includes the following steps. First, a plurality of color difference adjusting values corresponding to a plurality of reference brightness values are received. Next, target color difference adjusting value corresponding to brightness value of each pixel within the selected region is estimated according to the color difference adjusting values. Then, color difference value of each pixel within the selected region is adjusted according to target color difference adjusting value of each pixel within the selected region.

### BACKGROUND OF THE INVENTION

1. Field of the Invention

The invention relates in general to a device for adjusting image color difference value and an adjusting method thereof and more particularly to a device for adjusting image color difference value and an adjusting method thereof used for adjusting color difference value in different brightness (intensity) ranges.

2. Description of the Related Art

Image color is adjusted according to hue-saturation-intensity (HSI) in order to be in accordance with the general way of describing color.

FIG. 1A illustrates conventional chromaticity space of an image before and after hue is adjusted. Please referring to FIG. 1A, original chromaticity space H1 is converted to chromaticity space H2 by rotating with a hue rotating angle. However, the entire chromaticity space is adjusted by rotating the same hue rotating angle in this adjusting method.

FIG. 1B illustrates conventional chromaticity space of an image before and after saturation is adjusted. Please referring to FIG. 1B, original chromaticity space S1 is converted to chromaticity space S2 by multiplying a saturation gain. The same as the hue adjusting method, saturation of the entire chromaticity space is adjusted by multiplying a single saturation gain. Therefore, the saturation of the entire chromaticity space is adjusted in the same proportion.

As stated above, the conventional adjusting methods of hue and saturation only adjust the entire chromaticity space consistently. For those who need to adjust color precisely, such as artist, the conventional adjusting methods can not satisfy their need for color quality.

### SUMMARY OF THE INVENTION

The invention is directed to a device for adjusting image color difference value and an adjusting method thereof. Hue and saturation are adjusted in different brightness ranges individually. Therefore, customized need for color adjustment function is produced.

According to the present invention, a three-dimensional color difference value adjusting method for adjusting a selected region of an image is provided. First, a plurality of color difference adjusting values corresponding to a plurality of reference brightness values are received. Next, target color difference adjusting value of each pixel corresponding to brightness value of each pixel within the selected region are estimated according to the color difference adjusting values. Then, color difference value of each pixel within the selected region is adjusted according to target color difference adjusting value of each pixel within the selected region.

According to the present invention, a three-dimensional color difference value adjusting device is provided for adjusting a selected region of an image. The device includes a computing unit and an adjusting unit. The computing unit is used for computing target color difference adjusting value of each pixel corresponding to the brightness value of each pixel within the selected region according to a plurality of received color difference adjusting values and a plurality of corresponding reference brightness values. The adjusting unit is coupled to the computing unit and used for adjusting color difference value of each pixel within the selected region according to the brightness value and the target color difference adjusting value determined by the computing unit.

According to the present invention, a three-dimensional color difference value adjusting method is provided for adjusting a selected region of an image. First, a whole brightness interval which encompasses all brightness values of all pixels of the selected region is determined. Next, the whole brightness interval is partitioned into a plurality of brightness subintervals, wherein the brightness values at two ends of each brightness subinterval respectively correspond to given color difference adjusting values. Then, target color difference adjusting value corresponding to brightness value of each pixel is estimated within the selected region according to the brightness subinterval in which the brightness value of each pixel within the selected region is positioned. Afterwards, color difference value of each pixel within the selected region is adjusted according to target color difference adjusting value of each pixel within the selected region.

The invention will become apparent from the following detailed description of the preferred but non-limiting embodiments. The following description is made with reference to the accompanying drawings.

### BRIEF DESCRIPTION OF THE DRAWINGS

FIG. 1A (Prior Art) illustrates conventional chromaticity space of an image before and after hue is adjusted;

FIG. 1B (Prior Art) illustrates conventional chromaticity space of an image before and after saturation is adjusted;

FIG. 2 is a functional block diagram of a device for adjusting image color difference value according to a preferred embodiment of the invention;

FIG. 3 shows a diagram of the relationship of brightness values and color difference adjusting values;

FIG. 4 shows the chromaticity space in FIG. 1A after hue angles are adjusted by the adjusting method of color difference value according to the preferred embodiment of the invention;

FIG. 5 shows the chromaticity space in FIG. 1B after saturation is adjusted by the adjusting method of color difference value according to the preferred embodiment of the invention;

FIG. 6 is a flow chart of the adjusting method of color difference value according to the preferred embodiment of the invention; and

FIG. 7 is a flow chart of another adjusting method of color difference value according to the preferred embodiment of the invention.

### DETAILED DESCRIPTION OF THE INVENTION

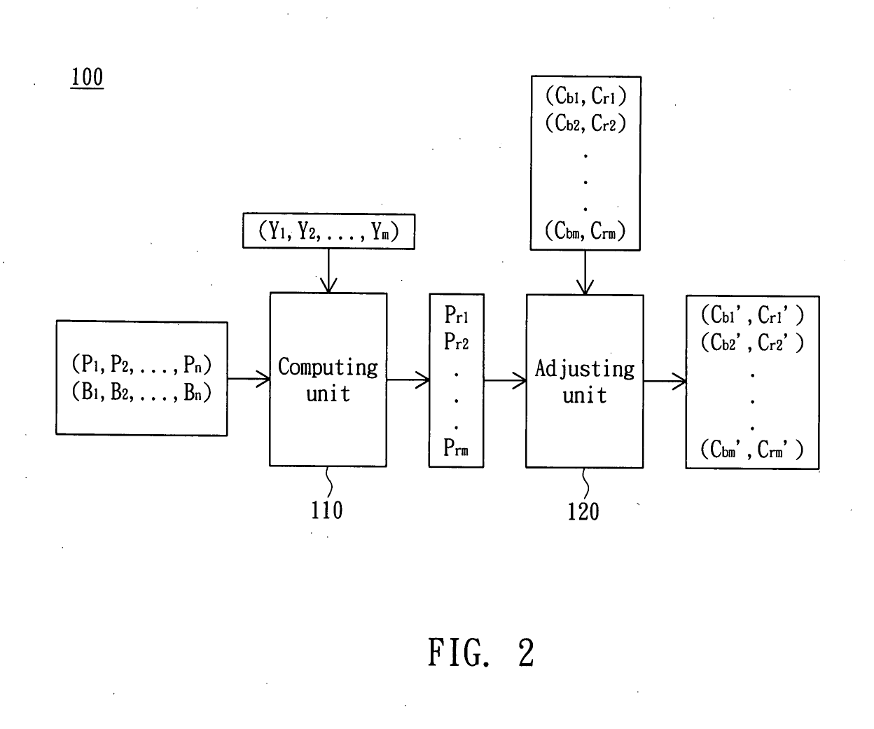

Please referring to FIG. 2, a functional block diagram of a device for adjusting image color difference value according to a preferred embodiment of the invention is shown. A device 100 is used for adjusting the image color difference value of a selected region of an image. Assuming the selected region includes m pixels, and the brightness values Y₁-Yₘ and the target color difference values Pᵣ₁-Pᵣₘ of the m pixels are defined. The device 100 includes a computing unit 110 and an adjusting unit 120. The computing unit 110 is used for computing target color difference adjusting value corresponding to the brightness value of each pixel within the selected region according to a plurality of received color difference adjusting values and a plurality of corresponding reference brightness values. As shown in FIG. 2, the computing unit 110 receives n reference brightness values B₁-Bₙ and corresponding color difference adjusting values P₁-Pₙ. The reference brightness values B₁-Bₙ form n−1 brightness intervals (B₁, B₂), (B₂, B₃) . . . (Bₙ₋₁, Bₙ), and color difference adjusting values form n−1 color difference adjusting value intervals (P₁, P₂), (P₂, P₃) . . . (Pₙ₋₁, Pₙ). When the brightness value of one of the m pixels within the selected region is positioned in one of n−1 brightness intervals, the target color difference adjusting value of the pixel is positioned in the corresponding color difference adjusting value interval.

In the present embodiment, assuming in the same brightness interval, a first pixel and a second pixel respectively have different brightness values Y₁ and Y₂, and different target color difference adjusting values Pr₁ and Pr₂. Preferably, the brightness values and the target color difference adjusting values of the pixels within the selected region are set to be linearly related, thus the target color difference adjusting value corresponding to the brightness value of each pixel can be obtained by linear interpolation.

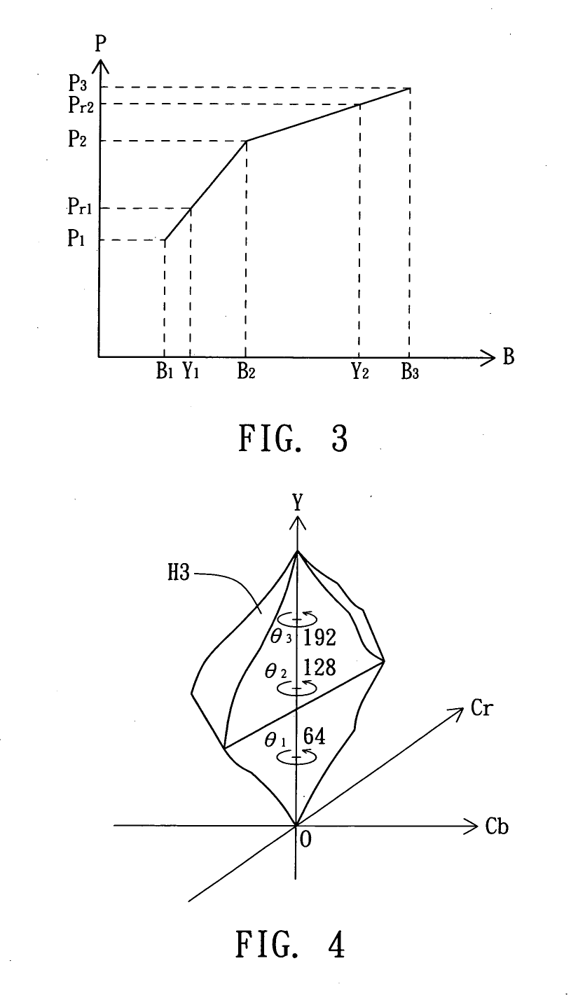

Referring to FIG. 3, a diagram shows the relationship of brightness values and color difference adjusting values. As shown in FIG. 3, brightness value Y₁ of the first pixel is assumed to be positioned in the brightness interval (B₁, B₂). Because the color difference adjusting value interval (P₁, P₂) corresponding to brightness interval (B₁, B₂) is given, and the brightness value and the color difference adjusting value is linearly related, target color adjusting value Pr₁ of the first pixel can be computed by linear interpolation.

Likewise, brightness value Y₂ of the second pixel positioned in the brightness interval (B₂, B₃) is given. Because corresponding color difference adjusting value interval (P₂, P₃) is given, target color difference adjusting value Pr₂ of the second pixel can be computed by linear interpolation.

The adjusting unit 120 is coupled to the computing unit 110 and used for computing color difference adjusting value of each pixel within the selected region according to brightness value of each pixel within the selected region and target color difference adjusting value determined by the computing unit 110.

For example, when the color difference adjusting value is a hue rotation angle, brightness value Y₁ of the first pixel is positioned between two brightness values Bₐ and B_{b}, and target hue rotation angle θᵣ₁ corresponding to brightness value Y₁ of the first pixel is positioned between two hue rotation angles θₐ and θ_{b}, target hue rotation angle θᵣ₁ can be computed by formula (1):

$$\frac{{θ}_{b} - {θ}_{a}}{{B}_{b} - {B}_{a}} = \frac{{θ}_{r 1} - {θ}_{a}}{{Y}_{1} - {B}_{a}} \qquad ( 1 )$$

Wherein θₐ and θ_{b} respectively correspond to brightness values Bₐ and B_{b}.

Then, according to computed target hue rotation angle θᵣ₁, the adjusting unit 120 adjusts color difference value (C_{b1}, Cᵣ₁) of the first pixel as:

C′_{b1}=C_{b1}·sin θᵣ₁+Cᵣ₁·cos θᵣ₁

C′ᵣ₁=Cᵣ₁·sin θᵣ₁−C_{b1}·cos θᵣ₁ (2)

Furthermore, when brightness value Y₂ of the second pixel is positioned between two brightness values B_{b} and B_{c}, target hue rotation angle θᵣ₂ corresponding to brightness value Y₂ of the second pixel is positioned between two hue rotation angles θ_{b} and θ_{c}, target hue rotation angle θᵣ₂ can be computed by formula (3):

$$\frac{{θ}_{c} - {θ}_{b}}{{B}_{c} - {B}_{b}} = \frac{{θ}_{r 2} - {θ}_{b}}{{Y}_{2} - {B}_{b}} \qquad ( 3 )$$

Wherein θ_{b} and θ_{c} respectively correspond to brightness values B_{b} and B_{c}, and the following expression is satisfied:

$$\frac{{θ}_{c} - {θ}_{b}}{{B}_{c} - {B}_{b}} \neq \frac{{θ}_{b} - {θ}_{a}}{{B}_{b} - {B}_{a}} \qquad ( 4 )$$

Then, according to computed target hue rotation angle θᵣ₂, the adjusting unit 120 adjusts color difference value (C_{b2}, Cᵣ₂) corresponding to brightness value Y₂ as:

C′_{b2}=C_{b2} sin θᵣ₂+Cᵣ₂·cos θᵣ₂

C′ᵣ₂=Cᵣ₂ sin θᵣ₂−C_{b2}·cos θᵣ₂ (5)

For example, assuming the brightness value ranges between 0 and 255. When brightness value B₁ is 64, hue rotation angle θ₁ is +5 degrees. When brightness value B₂ is 128, hue rotation angle θ₂ is +10 degrees. When brightness value B₃ is 192, hue rotation angle is +5 degrees.

Therefore, when brightness values B₁ and B₂ at two ends of the brightness interval to which brightness value Y₁ corresponds are 64 and 128 respectively, and corresponding hue rotation angles θ₁ and θ₂ are +5 degrees and +10 degrees respectively. Assuming Y₁ is equal to 80, target hue rotation angle θᵣ₁ is computed by substituting the values into the formula (1):

$$\frac{10 - 5}{128 - 64} = \frac{{θ}_{r 1} - 5}{80 - 64}$$

The computed target hue rotation angle θᵣ₁ is 6.25. Then, the computed hue rotation angle θᵣ₁, and original color difference value (C_{b1}, Cᵣ₁) when the brightness value is equal to 80 are substituted into the formula (2) to obtain the adjusted color difference value (C′_{b1}, C′ᵣ₁). Therefore, when brightness value of the first pixel ranges between brightness interval (64, 128), the adjusted color difference value (C′_{b1}, C′ᵣ₁) of the first pixel is computed by the above steps. Similarly, when the brightness value of the second pixel ranges between brightness interval (128, 192), adjusted color difference value (C′_{b2}, C′ᵣ₂) of the second pixel also can be computed by formula (3) and (5).

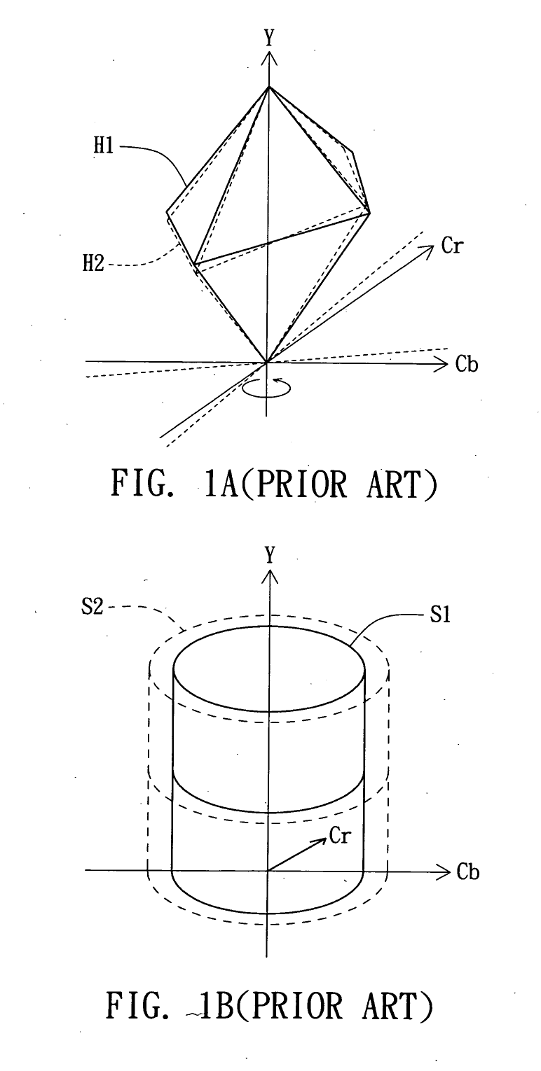

FIG. 4 shows the chromaticity space in FIG. 1A after hue angles are adjusted by the adjusting method of color difference value according to the preferred embodiment of the invention. When the brightness values are equal to 64, 128 and 192 respectively on Y-axis, the corresponding hue rotation angles θ₁, θ₂ and θ₃ are +5, +10 and +5 degrees respectively. The corresponding hue rotation angles corresponding to the rest brightness values are computed by linear interpolation. Therefore, the adjusted chromaticity space H3 is still smooth and continuous.

If color difference adjusting value is saturation gain value, and the brightness value Y₁ of the first pixel is between two brightness values Bₐ and B_{b}, target saturation gain value gᵣ₁ corresponding to brightness value Y₁ of the first pixel is between two received saturation gain values gₐ and g_{b}. Target saturation gain value gᵣ₁ is computed by formula (6):

$$\frac{{g}_{b} - {g}_{a}}{{B}_{b} - {B}_{a}} = \frac{{g}_{r 1} - {g}_{a}}{{Y}_{1} - {B}_{a}} \qquad ( 6 )$$

Wherein gₐ and g_{b} respectively correspond to brightness values Bₐ and B_{b}.

Then, the adjusting unit 120 computes and outputs adjusted color difference value (C′_{b1}, C′ᵣ₁) corresponding to brightness value Y₁ according to the computed target saturation gain value gᵣ₁ by:

C′_{b1}=C_{b1}·gᵣ₁

C′ᵣ₁=Cᵣ₁·tᵣ₁ (7)

Besides, when target saturation gain value gᵣ₂ corresponding to the second pixel is between two received saturation gain values g_{b} and g_{c}, target saturation gain value gᵣ₂ is computed by formula (8):

$$\frac{{g}_{c} - {g}_{b}}{{B}_{c} - {B}_{b}} = \frac{{g}_{r 2} - {g}_{b}}{{Y}_{2} - {B}_{b}} \qquad ( 8 )$$

Wherein g_{b} and g_{c} respectively correspond to brightness values B_{b} and B_{c}, and the following expression is satisfied:

$$\frac{{g}_{c} - {g}_{b}}{{B}_{c} - {B}_{b}} \neq \frac{{g}_{b} - {g}_{a}}{{B}_{b} - {B}_{a}} \qquad ( 9 )$$

Then, the adjusting unit 120 computes and outputs adjusted color difference value (C′_{b2}, C′ᵣ₂) corresponding to brightness value Y₂ according to the computed target saturation gain value gᵣ₂ by:

C′_{b2}=C_{b2}·gᵣ₂

C′ᵣ₂=Cᵣ₂·gᵣ₂ (10)

For example, assuming brightness value ranges between 0 and 255. When brightness value B₁ is equal to 64, saturation gain value g₁ is 1.5. When brightness value B₂ is equal to 128, saturation gain value g₂ is 2.0. When brightness value B₃ is equal to 192, saturation gain value g₃ is 1.5.

Therefore, when the brightness values Bₐ and B_{b} at two ends of corresponding brightness interval are 64 and 128 respectively, the corresponding saturation gain values Pₐ and P_{b} are 1.5 and 2.0 respectively. When Y₁ is equal to 80, target saturation gain value gᵣ₁ is computed by formula (6):

$$\frac{2.0 - 1.5}{128 - 64} = \frac{{g}_{r 1} - 1.5}{80 - 64}$$

The computed target saturation gain value gᵣ₁ is 1.625.

Afterwards, the computed target saturation gain value gᵣ₁, and the original color difference value (C_{b1}, Cᵣ₁) when brightness value Y₁ is equal to 80 are substituted into the formula (7) to obtain adjusted color difference value (C′_{b1}, C′ᵣ₁). Therefore, when brightness value ranges between brightness interval (64, 128), the corresponding adjusted color difference value is computed by the above steps. Similarly, when brightness value ranges between brightness interval (128, 192), the color difference value (C′_{b2}, C′ᵣ₂) can be computed from original color difference value (C_{b2}, Cᵣ₂) by formula (8) and (10).

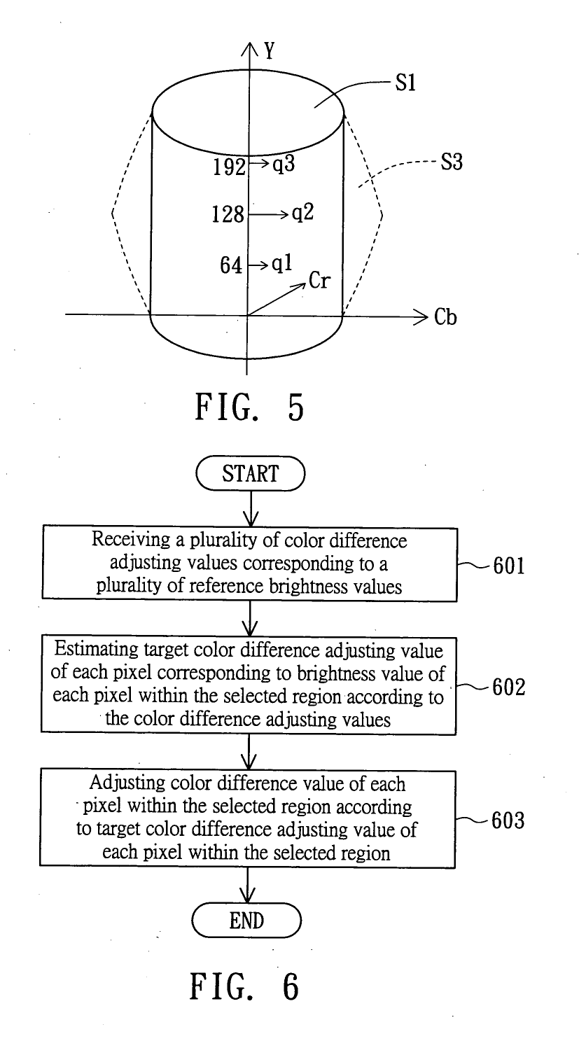

FIG. 5 shows the chromaticity space in FIG. 1B after saturation is adjusted by the adjusting method of color difference value according to the preferred embodiment of the invention. When the brightness values are equal to 64, 128 and 192 respectively on Y-axis, the saturation gain values g₁, g₂ and g₃ are 1.5, 2.0 and 1.5 respectively. Saturation gain values corresponding to the rest of brightness values are computed by linear interpolation. Therefore, the adjusted chromaticity space S3 is still smooth and continuous.

According to the device 100, the adjusting method of color difference value is shown as follow. Please referring to FIG. 6, a flow chart of the adjusting method of color difference value is illustrated. First, in step 601, a plurality of color difference adjusting values P₁-Pₙ corresponding to a plurality of reference brightness values B₁-Bₙ are received.

Next, in a step 602, target color difference adjusting value of each pixel corresponding to brightness value of each pixel within the selected region according to the color difference adjusting values P₁-Pₙ. When brightness value Y₁ of the first pixel is between Bₐ and B_{b}, and target color difference adjusting value Pᵣ₁ is between Pₐ and P_{b}, brightness value Y₁ and target color difference adjusting value Pr₁ is linear related. Thus target color difference adjusting value Pr₁ can be computed by linear interpolation. When target color difference adjusting value Pr₁ is a target hue rotation angle θᵣ₁, Pₐ and P_{b} are θₐ and θ_{b} respectively, target hue rotation angle θᵣ₁ can be computed by formula (1). When target color difference adjusting value Pr₁ is a target saturation gain value gᵣ₁, Pₐ and P_{b} are gₐ and g_{b} respectively, target saturation gain value gᵣ₁ can be computed by formula (6). Likewise, target hue rotation angle θᵣ₂ and target saturation gain value gᵣ₂ can be computed by formula (3) and (8) respectively.

Then, in a step 603, color difference value of each pixel within the selected region is adjusted according to target color difference adjusting value of each pixel within the selected region. When target color difference adjusting value Pr₁ is a target hue rotation angle θᵣ₁, (C′_{b1}, C′ᵣ₁) can be computed by formula (2). When target color difference adjusting value Pr₁ is a target saturation gain value gᵣ₁, (C′_{b1}, C′ᵣ₁) can be computed by formula (7). Likewise, When target color difference adjusting value Pr₂ is a target hue rotation angle θᵣ₂, (C′_{b2}, C′ᵣ₂) can be computed by formula (5). When target color difference adjusting value Pr₂ is a target saturation gain value gᵣ₂, (C′_{b2}, C′ᵣ₂) can be computed by formula (10).

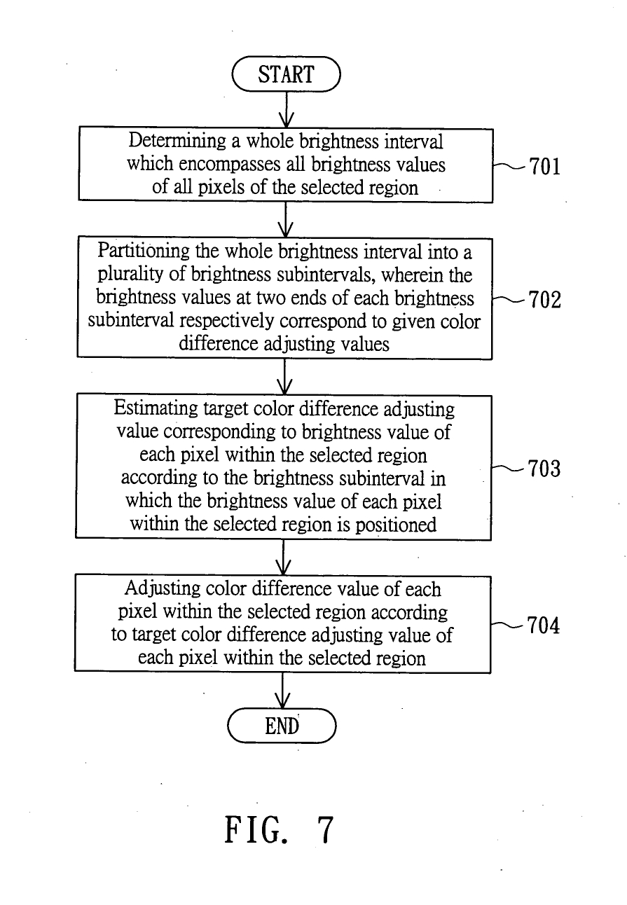

Those who skilled in the art of the invention can understand the present invention is not limited herein. Referring to FIG. 7, a flow chart of another adjusting method of color difference value is illustrated. First, in a step 701, a whole brightness interval which encompasses all brightness values of all pixels of the selected region is determined. For example, find out the minimum Yₘᵢₙ and maximum Yₘₐₓ among the brightness values Y₁-Yₘ of the m pixels, and choose the brightness interval (Yₘᵢₙ, Yₘₐₓ) as the whole brightness interval of the selected region.

Next, in a step 702, the whole brightness interval (Yₘᵢₙ, Yₘₐₓ) is partitioned into a plurality of brightness subintervals with even or uneven pitches, wherein the brightness values at two ends of each brightness subinterval respectively correspond to given color difference adjusting values.

Afterwards, in a step 703, target color difference adjusting value Pr₁-Prₘ corresponding to brightness value Y₁-Yₘ of the m pixels within the selected region according to the brightness subinterval in which the brightness value Y₁-Yₘ of the m pixels within the selected region is positioned. For example, assuming the brightness value and target color difference adjusting value of each pixel are linearly related, as a result of brightness values at two ends of each subinterval are given, target color difference adjusting values Pr₁-Prₘ of m pixels are computed by linear interpolation.

For example, If target color difference adjusting value Pr of a pixel is a target hue rotation angle θᵣ, and target hue rotation angle θᵣ of the pixel is between two hue rotation angles θₐ and θ_{b}, target hue rotation angle θᵣ is computed by formula (11):

$$\frac{{θ}_{b} - {θ}_{a}}{{B}_{b} - {B}_{a}} = \frac{{θ}_{r} - {θ}_{a}}{Y - {B}_{a}} \qquad ( 11 )$$

Wherein θₐ and θ_{b} correspond to brightness values Bₐ and B_{b} respectively.

For example, If target color difference adjusting value Pr of the pixel is a target saturation gain value gᵣ, and target saturation gain value gᵣ of the pixel is between two saturation gain values gₐ and g_{b}, target saturation gain value gᵣ is computed by formula (12):

$$\frac{{g}_{b} - {g}_{a}}{{B}_{b} - {B}_{a}} = \frac{{g}_{r} - {g}_{a}}{Y - {B}_{a}} \qquad ( 12 )$$

Wherein gₐ and g_{b} correspond to brightness values Bₐ and B_{b} respectively.

Then, in a step 704, color difference value of each pixel within the selected region is adjusted according to target color difference adjusting value Pr₁-Prₘ of the m pixels within the selected region.

When target color difference adjusting value Pr of a pixel is a target hue rotation angle θᵣ, target color difference value (C_{b}, Cᵣ) of the pixel is adjusted as (C′_{b}, C′ᵣ) by formula (13):

C′_{b}=C_{b}·sin θᵣ+Cᵣ·cos θᵣ

C′ᵣ=C_{r·sin θ}ᵣ−C_{b}·cos θᵣ (13)

When target color difference adjusting value Pr of the pixel is a target saturation gain value gᵣ, color difference value (C_{b}, Cᵣ) of the pixel is adjusted as (C′_{b}, C′ᵣ) by formula (14):

C′_{b}=C_{b}·gᵣ

C′ᵣ=Cᵣ·gᵣ (14)

By the image color difference value adjusting device and the adjusting method thereof according to the preferred embodiment of the invention, hue or saturation can be adjusted respectively according to different brightness value ranges. When the hue rotation angle θᵣ saturation gain value is computed according to different brightness value ranges by linear interpolation, the adjusted chromaticity space is still continuous and smooth.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A three-dimensional color difference value adjusting method for adjusting a selected region of an image, the method comprising:
receiving a plurality of color difference adjusting values corresponding to a plurality of reference brightness values;
estimating target color difference adjusting value of each pixel corresponding to brightness value of each pixel within the selected region according to the color difference adjusting values; and
adjusting color difference value of each pixel within the selected region according to target color difference adjusting value of each pixel within the selected region.

2. The method according to claim 1, wherein the reference brightness values form a plurality of brightness intervals, and the color difference adjusting values form a plurality of color difference adjusting value intervals which correspond to the brightness intervals, when one of the pixels of the selected region is positioned in one of the brightness intervals, the target color difference adjusting value of the one pixel is positioned in the corresponding color difference adjusting value interval.

3. The method according to claim 3, wherein a first pixel and a second pixel of the selected region respectively have a first brightness value and a second brightness value which are different, and the first brightness value and the second brightness value are positioned in the same brightness interval, the first pixel and the second pixel have a first target color difference adjusting value and a second target color difference adjusting value which are different.

4. The method according to claim 3, wherein the brightness value and the target color difference adjusting value of each pixel of the selected region are linearly related.

5. The method according to claim 4, when the color difference adjusting values are hue rotation angles and a target hue rotation angle θ₁ corresponding to a brightness value Y₁ of the first pixel is positioned between two received rotation angles θₐ and θ_{b}, the target hue rotation angle θ₁ is computed by:
$$\frac{{θ}_{b} - {θ}_{a}}{{B}_{b} - {B}_{a}} = \frac{{θ}_{1} - {θ}_{a}}{{Y}_{1} - {B}_{a}}$$
wherein θₐ and θ_{b} respectively correspond to brightness values Bₐ and B_{b}.

6. The method according to claim 5, when a target hue rotation angle θ₂ corresponding to a brightness value Y₂ of the second pixel is positioned between two received rotation angles θ_{b} and θ_{c}, the target hue rotation angle θ₂ is computed by:
$$\frac{{θ}_{c} - {θ}_{b}}{{B}_{c} - {B}_{b}} = \frac{{θ}_{2} - {θ}_{b}}{{Y}_{2} - {B}_{b}} ,$$
wherein θ_{b} and θ_{c} respectively correspond to brightness values B_{b} and B_{c}, and the following relationship is satisfied:
$$\frac{{θ}_{c} - {θ}_{b}}{{B}_{c} - {B}_{b}} \neq \frac{{θ}_{b} - {θ}_{a}}{{B}_{b} - {B}_{a}} .$$

7. The method according to claim 4, when the color difference adjusting values are saturation gain values and a target saturation gain value g₁ corresponding to brightness value Y₁ of the second pixel is between two received saturation gain values gₐ and g_{b}, the target saturation gain value g₁ is computed by:
$$\frac{{g}_{b} - {g}_{a}}{{B}_{b} - {B}_{a}} = \frac{{g}_{1} - {g}_{a}}{{Y}_{1} - {B}_{a}} ,$$
wherein gₐ and g_{b} respectively correspond to brightness values Bₐ and B_{b}.

8. The method according to claim 7, when a target saturation gain value g₂ corresponding to a brightness value Y₂ of the second pixel is positioned between two received rotation angles g_{b} and g_{c}, the target hue rotation angle g₂ is computed by:
$$\frac{{g}_{c} - {g}_{b}}{{B}_{c} - {B}_{b}} = \frac{{g}_{2} - {g}_{b}}{{Y}_{2} - {B}_{b}} ,$$
wherein g_{b} and g_{c} respectively correspond to brightness values B_{b} and B_{c}, and the following relationship is satisfied:
$$\frac{{g}_{c} - {g}_{b}}{{B}_{c} - {B}_{b}} \neq \frac{{g}_{b} - {g}_{a}}{{B}_{b} - {B}_{a}} .$$

9. A three-dimensional color difference value adjusting device for adjusting a selected region of an image, the device comprising:
a computing unit for computing target color difference adjusting value of each pixel corresponding to brightness value of each pixel within the selected region according to a plurality of received color difference adjusting values and a plurality of corresponding reference brightness values; and
an adjusting unit coupled to the computing unit and used for adjusting color difference value of each pixel within the selected region according to the brightness value and the target color difference adjusting value determined by the computing unit of each pixel within the selected region.

10. The device according to claim 9, wherein the reference brightness values form a plurality of brightness intervals, and the color difference adjusting values form a plurality of color difference adjusting value intervals which correspond to the brightness intervals, when one of the pixels of the selected region is positioned in one of the brightness intervals, the target color difference adjusting value of the one pixel is positioned in the corresponding color difference adjusting value interval.

11. The method according to claim 10, wherein a first pixel and a second pixel of the selected region respectively have a first brightness value and a second brightness value which are different, and the first brightness value and the second brightness value are positioned in the same brightness interval, the first pixel and the second pixel respectively have a first target color difference adjusting value and a second target color difference adjusting value which are different.

12. The method according to claim 11, wherein the brightness value and the target color difference adjusting value of each pixel of the selected region are linearly related.

13. The device according to claim 12, when the color difference adjusting values are hue rotation angles and a target hue rotation angle θ₁ corresponding to a brightness value Y₁ of the first pixel is between two received hue rotation angles θₐ and θ_{b}, the target hue rotation angle θ₁ is computed by:
$$\frac{{θ}_{b} - {θ}_{a}}{{B}_{b} - {B}_{a}} = \frac{{θ}_{1} - {θ}_{a}}{Y - {B}_{a}} ,$$
wherein θₐ and θ_{b} respectively correspond to brightness values Bₐ and B_{b}.

14. The device according to claim 13, when a target hue rotation angle θ₂ corresponding to a brightness value Y₁ is between two received hue rotation angles θₐ and θ_{b}, the target hue rotation angle θ₂ is computed by:
$$\frac{{θ}_{c} - {θ}_{b}}{{B}_{c} - {B}_{b}} = \frac{{θ}_{2} - {θ}_{b}}{{Y}_{2} - {B}_{b}} ,$$
wherein θ_{b} and θ_{c} respectively correspond to brightness values B_{b} and B_{c}, and the following relationship is satisfied:
$$\frac{{θ}_{c} - {θ}_{b}}{{B}_{c} - {B}_{b}} \neq \frac{{θ}_{b} - {θ}_{a}}{{B}_{b} - {B}_{a}} .$$

15. The device according to claim 12, when the color difference adjusting values are saturation gain values and a target saturation gain value g₁ corresponding to brightness value Y₁ of the first pixel is between two received saturation gain values gₐ and g_{b}, the target saturation gain value g₁ is computed by:
$$\frac{{g}_{b} - {g}_{a}}{{B}_{b} - {B}_{a}} = \frac{{g}_{1} - {g}_{a}}{{Y}_{1} - {B}_{a}}$$
wherein gₐ and g_{b} respectively correspond to brightness values Bₐ and B_{b}.

16. The device according to claim 15, when a target saturation gain value g₂ corresponding to brightness value Y₂ of the second pixel is between two received saturation gain values g_{b} and g_{c}, the target saturation gain value g₂ is computed by:
$$\frac{{g}_{c} - {g}_{b}}{{B}_{c} - {B}_{b}} = \frac{{g}_{2} - {g}_{b}}{{Y}_{2} - {B}_{b}} ,$$
wherein g_{b} and g_{c} respectively correspond to brightness values B_{b} and B_{c}, and the following relationship is satisfied:
$$\frac{{g}_{c} - {g}_{b}}{{B}_{c} - {B}_{b}} \neq \frac{{g}_{b} - {g}_{b}}{{Y}_{2} - {B}_{b}} .$$

17. A three-dimensional color difference value adjusting method for adjusting a selected region of an image, the method comprising:
determining a whole brightness interval which encompasses all brightness values of all pixels of the selected region;
partitioning the whole brightness interval into a plurality of brightness subintervals, wherein the brightness values at two ends of each brightness subinterval respectively correspond to given color difference adjusting values;
estimating target color difference adjusting value corresponding to brightness value of each pixel within the selected region according to the brightness subinterval in which the brightness value of each pixel within the selected region is positioned; and
adjusting color difference value of each pixel within the selected region according to target color difference adjusting value of each pixel within the selected region.

18. The method according to claim 17, wherein the brightness value and the target color difference adjusting value of each pixel of the selected region are linearly related.

19. The method according to claim 17, when the color difference adjusting values are hue rotation angles and a target hue rotation angle θ corresponding to a brightness value Y is positioned between two received rotation angles θₐ and θ_{b}, the target hue rotation angle θ is computed by:
$$\frac{{θ}_{b} - {θ}_{a}}{{B}_{b} - {B}_{a}} = \frac{θ - {θ}_{a}}{Y - {B}_{a}} ,$$
wherein θₐ and θ_{b} respectively correspond to brightness values Bₐ and B_{b}.

20. The method according to claim 17, when the color difference adjusting values are saturation gain values and a target saturation gain value g corresponding to brightness value Y is between two received saturation gain values gₐ and g_{b}, the target saturation gain value g is computed by:
$$\frac{{g}_{b} - {g}_{a}}{{B}_{b} - {B}_{a}} = \frac{g - {g}_{a}}{Y - {B}_{a}} ,$$
wherein gₐ and g_{b} respectively correspond to brightness values Bₐ and B_{b}.
